(19) United States
(12) Patent Application Publication
(10) Pub. No.: US 2007/0001583 A1
(43) Pub. Date: Jan. 4, 2007

(54) Light source, exposure apparatus, image display unit and medical device

(75) Inventors: Toshiyuki Nabeta, Kanagawa (JP); Kazuhiro Hasegawa, Kanagawa (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD., Minami-Ashigara-shi (JP)

(21) Appl. No.: 11/452,233

(22) Filed: Jun. 14, 2006

(30) Foreign Application Priority Data
Jun. 17, 2005 (JP) 2005-178070

(51) Int. Cl. H01J 1/62

(52) U.S. Cl. 313/500; 313/505

(57) ABSTRACT

To provide a light source including at least two linear pixels arranged in parallel on a substrate, wherein the linear pixels are configured by an organic electroluminescent device having a positive electrode, a negative electrode and at least one organic compound layer containing a light emitting layer between the positive electrode and the negative electrode, wherein an aspect ratio of the linear pixel is 200 or more, the positive electrode is shared by plural linear pixels, and the negative electrode is patterned according to the linear pixels. It is preferable that the film thickness of the negative electrode is 0.4 μm to 2 μm.

### CROSS-REFERENCE TO RELATED APPLICATION

This application claims priority under 35 USC 119 from Japanese Patent Application No. 2005-178070, the disclosure of which is incorporated by reference herein.

### BACKGROUND OF THE INVENTION

1. Field of the Invention

The present invention relates to a light source having an organic electroluminescent device for converting electric energy into light. Further, the present invention relates to an exposure apparatus, an image display unit, and a medical device having the light source.

2. Description of Related Art

A light source using an organic electroluminescent (EL) device is known. An organic electroluminescent device has advantages, such as giving light emission of a high luminance under a low voltage, making the device thin, and reduction in size and weight of the device. In a conventional tube, LED or the like used as a light source of an exposure apparatus, the volume of the light source is large, and it is difficult to obtain the evenness of the luminance (spacious and/or positional). In addition, when using an inorganic EL, it is difficult to obtain a necessary luminance (particularly, in the blue to green regions) and a complicated operational circuit due to alternate current operation and noise suppression are needed.

Accordingly, a light source using electroluminescence has been developed as an optical medium, and its light emission luminance depends on the position of the electroluminescence, particularly, depends on the position thereof in a longitudinal direction. The farther the electroluminescence is from a contact point between a lead and an electrode layer, the larger the resistance of the electrode layer is. Therefore, as a result, the light emission luminance of the electroluminescence far from the contact point is lowered. Therefore, a light source of an image reading unit using electroluminescence as an optical medium of which a width of an electroluminescence layer is adjusted to be the width corresponding to a distance from a contact point between an electrode layer and a lead has been suggested (see, for example, Japanese Patent Application Laid-Open (JP-A) No. 2002-325162).

In addition, as the light source, a linear light source has been demanded and an example of employing an organic EL device as its light emitting device is disclosed (see, for example, JP-A No. 2003-51380). Specifically, this publication discloses a linear light source having a linear self-luminous area formed along a longitudinal direction of the light source which is composed of an organic electroluminescent device. The linear light source includes a device substrate on which the organic electroluminescent device is formed and a sealing substrate which is adhered at the side where the organic electroluminescent device is formed on the device substrate by an adhesive and seals the organic electroluminescent device. The device substrate and the sealing substrate have conforming end faces at a long side of the light source.

However, in the case of using the organic electroluminescent device as the light source, particularly, in the case of applying an organic EL device as a light source made by arranging plural linear pixels, if a long- to short-side ratio of a pixel (namely, a ratio between a length in a longitudinal direction and a length in a lateral direction of the pixel and hereinafter, referred to as “an aspect ratio”) is large, a resistance of a negative electrode becomes larger. Therefore, this has a problem that generation of the unevenness of the luminance due to voltage drop is expected.

There is fear that the voltage may drop at a positive electrode using a transparent metal oxide having a larger resistance than that of a negative electrode normally made of a metal, however, the voltage drop at the positive electrode can be prevented when the positive electrode is not patterned. On the other hand, it seems that the problem of the voltage drop at the negative electrode made of a metal is not so serious compared with the positive electrode, however, the voltage drop is increased in proportion to the long- to short-side ratio of the linear pixel. In the light source including the linear pixel having a large aspect ratio, the voltage drop at the negative electrode that does not give any problems conventionally becomes significant.

### SUMMARY OF THE INVENTION

The present invention has been devised in the light of the above circumstances and provides a light source having at least two linear pixels arranged in parallel on a substrate, wherein the linear pixels comprise an organic electroluminescent device and have a large aspect ratio. In addition, the invention provides an exposure apparatus, an image display unit, and a medical device having the light source according to the invention.

According to a first aspect of the invention, there is provided a light source comprising at least two linear pixels arranged in parallel on a substrate, wherein the linear pixels comprise an organic electroluminescent device comprising a positive electrode, a negative electrode and at least one organic compound layer containing a light emitting layer between the positive electrode and the negative electrode, wherein an aspect ratio of the linear pixel is 200 or more, the positive electrode is shared by a plurality of linear pixels, and the negative electrode is patterned according to the linear pixels.

According to a second aspect of the invention, there is provided the light source of the first aspect, wherein the film thickness of the negative electrode is 0.4 μm to 2 μm.

According to a third aspect of the invention, there is provided the light source of the first or second aspect, wherein the negative electrode has a laminated structure, and the laminated structure comprises: a layer made of a material with a work function of 4 eV or less; and a layer made of a material with a volume resistivity lower than that of the layer with the work function of 4 eV or less, provided in the above order from the side of the organic compound layer.

According to a fourth aspect of the invention, there is provided the light source of the first or second aspect, wherein the negative electrode has a laminated structure, and the laminated structure comprises an aluminum layer and a silver layer, or an aluminum layer and a copper layer in the above order from the side of the organic compound layer.

According to a fifth aspect of the invention, there is provided the light source of the fourth aspect, wherein the film thickness of the aluminum layer is 0.01 μm to 0.05 μm, and the film thickness of the silver layer or the copper layer is 0.4 μm or more.

According to a sixth aspect of the invention, there is provided the light source of any one of the first to fifth aspects, wherein the film thickness of the light emitting layer is 0.06 μm to 0.4 μm.

According to a seventh aspect of the invention, there is provided the light source of any one of the first to sixth aspects, wherein the organic electroluminescent device comprises an organic compound layer, including two or more light emitting layers, between the positive electrode and the negative electrode, and a charge generating layer is formed between the two or more light emitting layers.

According to an eighth aspect of the invention, there is provided an exposure apparatus comprising the light source of any one of the first to seventh aspects.

According to a ninth aspect of the invention, there is provided an image display unit comprising the light source of any one of the first to seventh aspects as an image display part.

According to a tenth aspect of the invention, there is provided a medical device comprising the light source of any one of the first to seventh aspects.

### BRIEF DESCRIPTION OF THE DRAWINGS

FIG. 1A is a top view of an embodiment of a light source according to the invention;

FIG. 1B is a cross sectional view taken on a line A-A of FIG. 1A; and

FIG. 2 is a schematic view showing an example of an organic electroluminescent device having charge generating layers between plural light emitting layers, which is used as a light source of the invention.

### DETAILED DESCRIPTION OF THE INVENTION

A light source according to an embodiment of the present invention will be described in detail below.

A light source according to an embodiment of the invention comprises at least two linear pixels arranged in parallel on a substrate, wherein the linear pixels comprise an organic electroluminescent device comprising a positive electrode, a negative electrode and at least one organic compound layer containing a light emitting layer between the positive electrode and the negative electrode, wherein an aspect ratio of the linear pixel is 200 or more, the positive electrode is shared by a plurality of the linear pixels, and the negative electrode is patterned according to the linear pixels.

The linear pixels in the invention are made of an organic EL device, and at least two linear pixels are arranged in parallel on the substrate. Considering the light source for reading an image and the light source for display an image, the number of the arranged pixels is preferably ten or more; more preferably one hundred or more; and still more preferably one thousand or more.

A pixel pitch is preferably 1.1 times to 10 times as large as the width of the pixel; and more preferably 1.5 times to 3 times. If the pixel pitch is 1.1 times or less, a space between a pixel and a pixel adjacent to the pixel becomes too narrow and, therefore, it difficult to obtain separation between the pixels and electrical insulation thereof. On the other hand, if the pixel pitch is 10 times or more, a space between a pixel and a pixel adjacent to the pixel becomes too broad and, therefore, it is difficult to read an image with a high degree of accuracy and a visual effect of the display may be impaired.

A long- to short-side ratio (aspect ratio) in the invention is a value expressed by dividing a length in a longitudinal direction by a length in a direction perpendicular to the longitudinal direction of the organic EL device.

It is necessary that a long- to short-side ratio (aspect ratio) of the linear pixel is in a range of 200 or more and an upper limit thereof is not particularly defined, but is preferably 16,000 or less. The aspect ratio is preferably 300 to 16,000; more preferably, 500 to 16,000; and still more preferably, 1,000 to 10,000. Particularly, the aspect ratio is preferably 2,000 to 10,000, and most preferably, 5,000 to 10,000.

For example, when the light source is used as a light source for displaying a poster in an A1 size and with a width of 600 mm, an aspect ratio of the linear pixel is in a range of 200 to 1,000. When the light source is used as a light source for reading a document such as fax in an A4 size, an aspect ratio of the linear pixel is 1,000 to 10,000. When the light source is used as a light source for reading a film or the like, an aspect ratio of the linear pixel is 2,000 to 16,000.

If the aspect ratio is 200 or less, a light emission area is too large, and therefore, it is difficult to read an image with a high degree of accuracy and the visual effect of the display may be impaired. In addition, if the aspect ratio exceeds 16,000, the voltage drop at the negative electrode becomes too large, and therefore, the unevenness of the luminance due to the voltage drop may exceed the allowable range.

A length of the linear pixel in a longitudinal direction (pixel length) can be appropriately set according to the applied mode of the light source, however, the length is preferably 10 mm to 1000 mm, and more preferably 100 mm to 500 mm. In addition, a length in a direction perpendicular to the longitudinal direction of the pixel can be appropriately set according to the applied mode of the light source, however, this length is preferably 5 μm to 5000 μm, and more preferably 20 μm to 1000 μm.

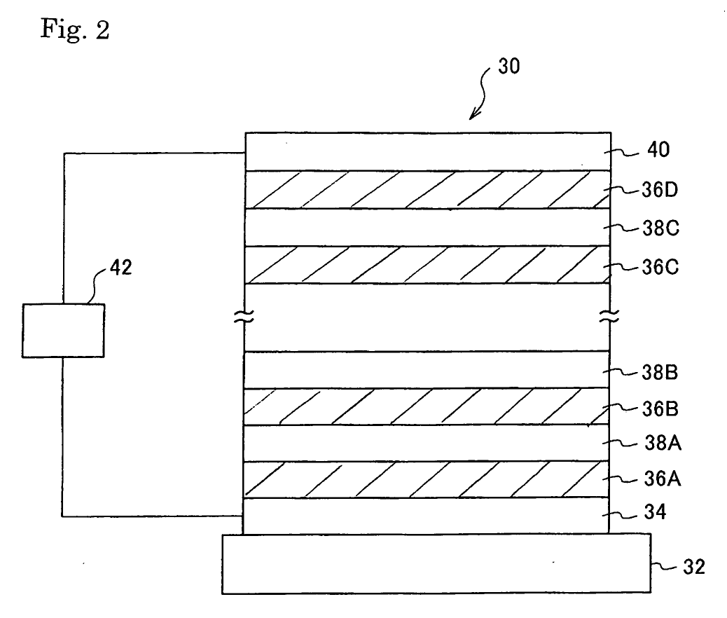

FIG. 2 shows an example of an organic electroluminescent device having charge generating layers between plural light emitting layers, which is used as a light source of the invention. In the organic electroluminescent device, a positive electrode is shared by plural pixels, and a negative electrode is patterned according to the pixels. In addition, as shown in FIG. 2, the organic electroluminescent device comprises at least one organic compound layer containing an emitting layer. Other than the emitting layer, the organic electroluminescent device may have a positive hole injection layer, a positive hole transport layer, an electron injection layer, and an electron transport layer or the like.

A method of forming the light source according to the invention is not particularly limited. For example, a method of forming the light source by forming an electrode (positive electrode) on a substrate; forming an insulating layer on this electrode; removing the insulating layer corresponding to a linear pixel forming part by etching or the like; and further, sequentially forming an organic compound layer and an electrode (a negative electrode) is considered. According to this forming method, the positive electrode disposed on the substrate is shared by plural pixels and the negative electrode can be patterned according to the pixel. In addition, by using a shadow mask corresponding to the linear pixel, the organic compound layer and the electrode (negative electrode) can be sequentially formed on the electrode (positive electrode).

The shape of the light source according to an embodiment of the invention is not particularly limited, however, the light source takes rectangle type in which the linear pixels are vertically arranged in parallel, typically. In order to improve the visual effect, the light source can also take parallelogram type in which the linear pixels are inclined and arranged. They have typically flat faces, however, considering of reading a document on a platen, they may have curved faces.

In addition, the size of the light source is not particularly limited, however, it is possible to set the size of the light source according to an object of reading, for example, a 35 mm film, a sheet in a A size or a B size, a film for a medical use, a radiographic image conversion panel, and a display sign board or the like.

Each component part of the organic EL device composing the linear pixels in the invention will be described further in detail with reference to the drawings below.

A negative electrode may supply an electron to an electron injection layer, an electron transport layer, and a light emitting layer or the like, and the negative electrode is selected in consideration of adherence with a layer adjacent to the negative electrode in the electron injection layer, the electron transport layer, and the light emitting layer or the like, ionization potential, and stability or the like. As described above, the negative electrode in the invention is patterned according to the pixels.

From the viewpoint of preventing generation of luminance unevenness by suppressing the voltage drop, the film thickness of the negative electrode is preferably 0.4 μm to 2 μm, and more preferably, 0.6 μm to 1.5 μm. When the film thickness of the negative electrode is 2 μm or more, the internal stress after the negative electrode is manufactured becomes too large and peeling of the negative electrode or the like may occur.

As a material of the negative electrode, a metal, an alloy, a metal halide, a metal oxide, a conductive compound or a composite of these materials can be used. Specific examples of the materials include an alkali metal such as Li, Na, K or the like, and fluorides or oxides thereof; an alkali earth metal such as Mg, Ca or the like and fluorides or oxides thereof; gold, silver, lead, aluminum, a sodium-potassium alloy or mixed metals thereof; lithium-aluminum alloy or mixed metals thereof; magnesium-silver alloy or mixed metals thereof; and a rare earth metal such as indium and ytterbium or the like. Preferably, the material is a material having a work function of 4 eV or less; and more preferably, it is aluminum, a lithium-aluminum alloy or mixed metals thereof; and magnesium-silver alloy or mixed metals thereof or the like.

Among these materials, aluminum is particularly preferable from the viewpoints of low work function, chemical stability, cost, and production suitability.

The negative electrode in the invention can be formed not only as a single layer structure but also as a laminated structure.

From the viewpoint of preventing the voltage drop, as the material of the negative electrode, the material having a lower volume resistance than that of silver, copper or the like can be used. However, these materials may decrease the light emission luminance and the light emission efficiency due to drop of the electron injection efficiency according to the work function. Accordingly, when the negative electrode has a laminated structure, it is preferable that the laminated structure comprises a layer made of a material having a work function of 4 eV or less and a layer made of a material having a volume resistance lower than that of the layer having the work function of 4 eV or less, provided in the above order from the side of the organic compound layer. Specifically, it is preferable that the negative layer has a laminated structure, and as a layer located at the side of the organic compound layer among the layers composing the laminated structure, for example, a layer using a material with a lower work function such as aluminum is formed and next to this layer, layers using materials with a lower volume resistance such as silver or copper are formed, thereby obtaining balance of prevention of the voltage drop with the light emission luminance and the light emission efficiency. By forming the negative electrode as a laminated structure as described above, it is possible to make the negative electrode thinner than that of a single layer structure, and therefore, higher luminance and efficiency than those for the negative electrode made of a single material can be achieved while prevention of the voltage drop has the same as that of a single layer structure.

In an embodiment of the invention, the negative electrode has a laminated structure, and the laminated structure comprises an aluminum layer and a silver layer, or an aluminum layer and a copper layer, provided in the above order from the side of the organic compound layer. When the negative electrode is of the aluminum layer and the silver layer, or the aluminum layer and the copper layer, each of these layers preferably has a film thickness as follows. Note that, in the aluminum layer and the silver layer or the aluminum layer and the copper layer, impurities of an inorganic material and/or an organic material may be contained to a degree that the advantage of the invention is not lowered. The aluminum layer is a layer of which main component is aluminum, and preferably, it is a layer only composed of aluminum. The silver layer is a layer of which main component is silver, and preferably, it is a layer only composed of silver. The copper layer is a layer of which main component is copper, and preferably, it is a layer only composed of copper.

The film thickness of the aluminum layer is preferably 0.01 μm to 0.05 μm so as to keep the evenness of the film.

From the viewpoint of preventing the voltage drop, it is preferable that the film thickness of the silver layer or the copper layer is 0.4 μm to 2.0 μm, and more preferably, 0.6 μm to 1.5 μm.

In an embodiment of the laminated structure of the organic compound layer in the invention, a positive hole transport layer, a light emitting layer, and an electron transport layer are formed in this order from the positive electrode side. Further, a charge blocking layer or the like may be disposed between the positive hole transport layer and the light emitting layer, or between the light emitting layer and the electron transport layer. A positive hole injection layer may be disposed between the positive electrode and the positive hole transport layer, and an electron injection layer may be disposed between the negative electrode and the electron transport layer. In addition, the light emitting layer may be one layer or the light emitting layer may be divided into a first light emitting layer, a second light emitting layer, and a third light emitting layer. Further, each layer may be further divided into plural second layers.

The light emitting layer may receive the positive hole from the positive electrode, the positive hole injection layer, or the positive hole transport layer upon application of the electric field and receive the electron from the negative electrode, electron injection layer or the electron transport layer, thereby providing a filed where the positive hole is recombined to the electron so as to emit a light.

The light emitting layer in the invention may be composing of only a luminescence material or it may be composed of a mixed layer having a host material and a luminescence material mixed therein. The luminescence material may be a fluorescence material or a phosphorescence material. One luminescence material may be used alone or two or more luminescence materials may be used in combination. The host material is preferably a charge transport material. One host material may be used alone or two or more host materials may be used in combination. Examples thereof include a structure in which a host material with an electron transportability is mixed with a host material with a hole transportability. Further, the light emitting layer may include a material that does not emit a light without the charge transportability.

In addition, the light emitting layer may be one or more layers and each layer may emit a light of a different color, respectively.

From the viewpoints of the luminance unevenness, the driving voltage, and the luminance, the film thickness of the light emitting layer is preferably 0.03 μm to 0.5 μm, and more preferably, 0.06 μm to 0.4 μm. If the film thickness of the light emitting layer is thin, the organic electroluminescent device of the embodiment can be driven at a high luminance and a low voltage. However, the light emitting layer is easily influenced by drop of the voltage because the device resistance is small, resulting in increase of the luminance unevenness due to the voltage drop. If the film thickness of the light emitting layer is thick, the driving voltage becomes high, and therefore, the efficiency of the light emission decreases, resulting in limit the use thereof.

In addition, when the light emitting layer has the laminated structure, the film thickness of each layer composing the laminated structure is not particularly limited, but it is preferable that the total film thicknesses of respective light emitting layers is within the above-described range.

Examples of the fluorescence material to be used in the present are not particularly limited and can be appropriately selected from the known materials. For example, the materials described in a paragraph (0027) of JP-A No. 2004-146067 and a paragraph (0057) of JP-A No. 2004-103577 or the like may be used, but the invention is not limited thereto.

In addition, the fluorescence material to be used in the invention is not particularly limited and may be appropriately selected from the known materials. For example, materials described in paragraphs (0051) to (0057) of JP-A No. 2004-221068 can be used, but the invention is not limited thereto.

Examples of the other component parts such as the substrate, the electrode, each organic compound layer, and other layers in the organic electroluminescent device in the invention include, for example, those described in paragraphs (0013) to (0082) of JP-A No. 2004-221068; paragraphs (0017) to (0091) of JP-A No. 2004-214178; paragraphs (0024) to (0035) of JP-A No. 2004-146067; paragraphs (0017) to (0068) of JP-A No. 2004-103577; paragraphs (0014) to (0062) of JP-A No. 2003-323987; paragraphs (0015) to (0077) of JP-A No. 2002-305083; paragraphs (0008) to (0028) of JP-A No. 2001-172284; paragraphs (0013) to (0075) of JP-A No. 2000-186094; and paragraphs (0016) to (0118) of JP-A No. 2003-515897, but the invention is not limited thereto.

As a driving method of the organic electroluminescent device in the invention, the driving methods described in each of JP-A Nos. 2-148687, 6-301355, 5-29080, 7-134558, 8-234685, and 8-241047, and Japanese Patent No. 2784615, U.S. Pat. Nos. 5828429 and 6023308 or the like can be applied.

The organic EL device in the invention may be a structure having the charge generating layers between plural layers of the laminated light emitting layer in order to improve the light emission efficiency. Such a structure is preferable since it can increase a resistance of the organic EL device and can ease effects due to the voltage drop.

The charge generating layer has a function to generate a charge (a positive hole and an electron) upon application of the electric field, together with a function to inject the generated charge into the layer adjacent to the charge generating layer.

A material forming the charge generating layer may be any material having the above-described functions and it may be formed from a single compound or a plurality of compounds.

Specifically, the material may be a material having conductivity or having semiconductivity such as a doped organic layer or having electrical isolation. For example, examples of the materials include those described in each publication of JP-A Nos. 11-329748, 2003-272860, and 2004-39617.

Further, the specific examples include a transparent electrical conducting material such as ITO and IZO (indium zinc oxide); a conductive organic material such as fullerenes (for example, C60) and an oligothiophene; a conductive organic material such as metal phthalocyanines, metal free phthalocyanines, metal porphyrins and metal free porphyrins; a metal material such as Ca, Ag, Al, Mg: Ag alloy, Al:Li alloy, and Mg:Li alloy; a positive hole conducting material, an electron conducting material, and combinations thereof.

Examples of the positive hole conducting material include positive hole transport organic materials such as 2-TNATA (4,4′,4″-tris[N-(2-naphthyl)-N-(phenylamino)triphenylamine])and NPD doped with an oxidizing agent having an electron withdrawing property such as F4-TCNQ(7,7,8,8-tetrafluoro-2,3,5,6-tetracyanoquinodimethane), TCNQ(7,7,8,8-tetrafluoro-2,3,5,6-tetracyanoquinodimethane), and FeCl₃, a P-type conductive polymer, and a P-type semiconductor or the like. The electron conducting material may include the electron transport organic material doped with a metal or a metallic compound having a work function less than 4.0 eV, an N-type conductive polymer, and an N-type semiconductor or the like. Examples of the N-type semiconductor may include an N-type Si, an N-type CdS, and an N-type ZnS or the like. Examples of the P-type semiconductor may include a P-type Si, a P-type CdTe, and a P-type CuO or the like.

Further, as the charge generating layer, an electric insulating material such as V₂O₅ may be used.

The charge generating layer may be a single layer or multilayer. Examples of the multilayer structure include a structure in which a conductive material such as a transparent electrical conducting material and a metal material and a positive hole conducting material, or an electron conducting material are laminated; and a structure in which the above-described positive hole conducting material and the electron conducting materials are laminated.

With respect to the charge generating layer, a film thickness and a material are preferably selected so that a transmission factor of a visible light is 50% or more. In addition, the film thickness is not particularly limited, however, it is preferably 0.5 to 200 nm, more preferably 1 to 100 nm, still more preferably 3 to 50 nm, and still further preferably 5 to 30 nm.

A method of forming the charge generating layer is not particularly limited and a method of forming the organic compound layer may be applicable.

The charge generating layer is formed between plural layers of the laminated light emitting layer; however, at the side of the positive electrode and the side of the negative electrode of the charge generating layer, the charge generating layer may contain a material having a function to inject the charge into the adjacent layer. In order to improve a performance of injecting the electron into the layer adjacent to the side of the positive electrode, for example, an electron injecting compound such as BaO, SrO, Li₂O, LiCl, LiF, MgF₂, MgO, and CaF₂ may be laminated at the side of the positive electrode of the charge generating layer.

In addition to the above described materials, the material of the charge generating layer can be selected from those described in each specification of JP-A No. 2003-45676, U.S. Patent Nos. 6337492, 6107734, and 6872472 or the like.

An embodiment of a light source according to the invention will be described below; however, the invention is not limited thereto.

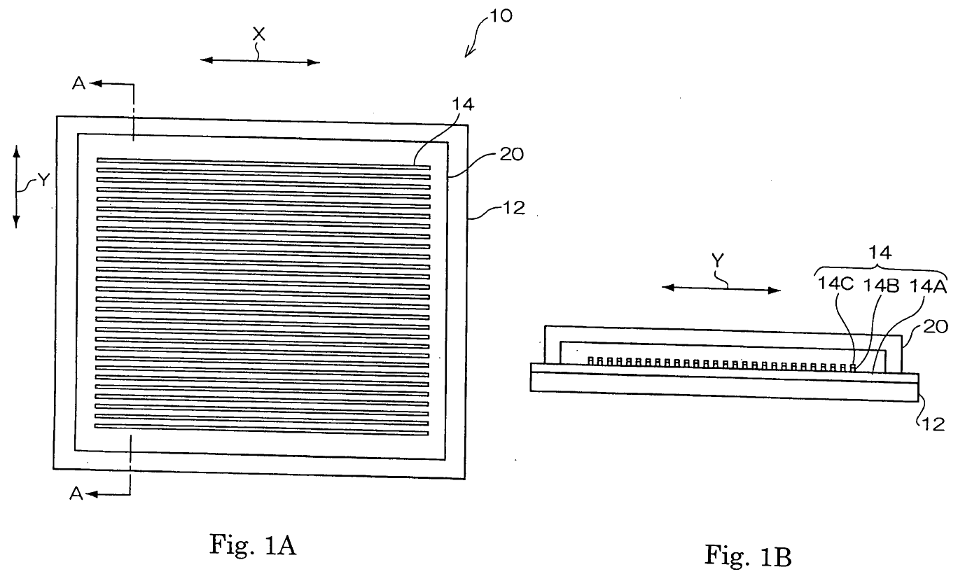

FIG. 1A is a top view of an embodiment of a light source according to the invention and FIG. 1B is a cross sectional view taken on a line A-A of FIG. 1A.

In FIG. 1A, a light source 10 comprises a substrate 12, linear pixels 14 which are made of organic EL devices and are arranged in parallel on the substrate 12, and a sealing member 20.

The linear pixels 14 are arranged in parallel in a Y direction so that its longitudinal direction conforms with the end of the substrate 12 along a X direction. The long- to short-side ratio (aspect ratio) of the linear pixel is 200 or more.

As shown in FIG. 1B, the linear pixel 14 comprises an electrode 14A (a positive electrode), an opposing electrode 14C (a negative electrode) and an organic compound layer 14B between the electrode 14A and the electrode 14C.

The embodiment has the sealing member 20. The sealing member 20 is a sealing member having a reverse concave shape, and has a function to cover the entire linear pixel 14 arranged in parallel to seal it onto the substrate 12.

Further, FIG. 2 is a schematic view showing an example of an organic electroluminescent device having charge generating layers between plural light emitting layers, which is used as a light source of the invention. As shown in FIG. 2, an organic electroluminescent device in a light source of the invention is designated as 30. The organic EL device 30 comprises a substrate 32 on which a positive electrode 34 and a negative electrode 40 are formed, and between the positive electrode and the negative electrode, organic compound layers 36A, 36B, 36C and 36D, each layer of which containing a light emitting layer, and between the organic compound layers containing the light emitting layers, are provided charge generating layers 38 A, 38B and 38C. The positive electrode 34 and the negative electrode 40 are connected through a power source 42.

Regarding the organic compound layers 36A, 36B, 36C and 36D, each layer of which containing a light emitting layer, the layers may be the same composition as each other or different. Regarding the charge generating layers 38 A, 38B and 38C, the layers may be the same composition as each other or different.

In an embodiment of the invention, a passive driving method may be applied. The negative electrode is connected to a scanning electrode line because the positive electrode is used as a common electrode. For the reading light source, the scanning electrode line is sequentially scanned. For the display light source, the scanning electrode line is randomly driven to make it possible to create various visual effects. In addition, in the case of dividing the positive electrode so as to include a plurality of pixels, it is also possible to use a multi-scanning system for scanning each block of the divided positive electrode.

It is possible to obtain light emission by applying a direct voltage, which may also contain an alternate current component if desired, (normally 2 to 30 volts, and when light emitting layers are laminated with charge generating layers therebetween, this voltage×the number of laminated light emitting layers), or a direct current between the positive electrode and the negative electrode.

An important parameter of the organic EL device may include external quantum efficiency. The external quantum efficiency is calculated by “external quantum efficiency φ=the number of photons discharged from the element/the number of electrons injected into the element”. In the external quantum efficiency, the larger the value is, the more the element is advantageous in electric power consumption.

In addition, the external quantum efficiency of the organic EL device is decided by “external quantum efficiency φ=internal quantum efficiency×light-extraction efficiency”. In the organic EL device using a fluorescent light emission from the organic compound, a limit value of the internal quantum efficiency is 25% and the light-extraction efficiency is about 20%, so that a limit value of the external quantum efficiency is about 5%.

As the external quantum efficiency of the organic EL device, 6% or more is preferable and 12% or more is more preferable for enabling decrease of the electric power consumption and increase of driving durability.

As the value of this external quantum efficiency, the highest value of the external quantum efficiency when the device is driven with a constant voltage at 20° C. can be used.

A direct current constant voltage is applied to the EL device to emit light by using a source measure unit 2400 manufactured by TOYO Corporation, and the luminance is measured by using a luminance meter BM-8 manufactured by a TOPCON CORPORATION. On the other hand, wavelength at the light emission peak and waveforms of the light emission spectrum are measured by using a spectrum analyzer PMA-11 manufactured by Hamamatsu Photonics K.K. to calculate the external quantum efficiency.

In addition, the external quantum efficiency of the organic EL device can be calculated from a relative luminosity curve and the measuring results of a light emission luminance, a light emission spectrum and a current density. In other words, by using a current density value, the number of the inputted electrons can be calculated. Then, by an integral computation using a light emission spectrum and a relative luminosity curve (spectrum), the light emission luminance can be expressed by the number of photons which emitted light. Thus, the external quantum efficiency (%) can be calculated from “(the number of photons which emitted light/the number of electrons which inputted in the device)×100”.

The internal quantum efficiency of the organic EL device can be calculated by the equation: internal quantum efficiency=external quantum efficiency/light-extraction efficiency. In the normal organic EL device, the light-extraction efficiency is about 20%, however, in the invention, it is possible to make the light-extraction efficiency to be 20% or more depending on the shape of the substrate, the shape of the electrode, the film thickness of the organic layer, the film thickness of the inorganic layer, a refraction factor of the organic layer, and a refraction factor of the inorganic layer or the like.

In the light source according to an embodiment of the invention, the expression “luminance unevenness (%)” is used as a parameter when the luminance unevenness does not occur between the end and the center of the linear pixel and is calculated by “(luminance at a central part/luminance at an end part)×100”. Here, the “end part” and the “central part” mean positions in a longitudinal direction of the linear pixel. More specifically, the “end part” means either one of the position toward the center of the linear pixels separated from the edge by 5 mm or 5% of the length of a long side in order to escape from the influence of significant luminance unevenness at the very edge of the linear pixel, and the “central part” means a middle point of the length of the long side of the linear pixel.

The luminance unevenness is not such a serious problem when the light source is used as a sign light source, but when it is used as a reading light source, the luminance unevenness is preferably 70% or more, more preferably, 80% or more, and still more preferably, 90% or more. When requesting a high degree of reading accuracy, the luminance unevenness is particularly preferably 95% or more.

When the luminance unevenness is 70% or less, the linear pixel deviates from the linear range of an output signal of a detector for the light amount of the reading light source, and it may be difficult to correct the linear pixel by a detection circuit and software.

The usage of the light source according to the invention is not particularly limited, however, the light source can be preferably used as a document reading light source of a scanner, a fax, a film or the like; a latent image reading light source of a radiographic image conversion panel; a display sign light source; and a back light source of an advertising display or the like. An exposure apparatus according to the invention comprises a light source of the invention as a light source part irradiating a light onto a desired pattern or the like. Such an exposure apparatus according to the invention, besides having the above-described light source of the invention, can be generally configured by using various members such as a transport mechanism for transporting a document, a recording medium, or the like; an array type or planar type photodetector for detecting reflected light or transmitted light from the document; a drum type photoreceptor for forming an image; an optical shutter for partially transmitting light emitted from the light source; or the like. Examples of the exposure apparatus in which the light source according to the invention can be provided include apparatuses described in the publications of JP-A Nos. 8-44163 and 8-298563, the disclosures of which are incorporated by reference herein.

In addition, an image display unit according to the invention comprises the light source of the invention as an image display part (a display). The image display unit according to the invention, besides having the above-described light source of the invention, can be generally configured by using various members such as a holding member for holding an image medium; a transport mechanism for transporting the image medium; an optical shutter for partially transmitting light emitted from the light source; or the, like. Examples of the image display unit in which the light source according to the invention can be provided include units described in the publications of JP-A No. 10-228250, International Publication (WO) No. 2003-507751 and Japanese Patent No. 2991452, the disclosures of which are incorporated by reference herein.

Further, the invention may provide a medical device comprising the light source of the invention, preferably, as a light source for a medical use such as a medical device for reading image information (preferably, a radiographic image conversion panel). The medical device according to the invention, besides having the above-described light source of the invention, can be generally configured by using various members such as a radiographic image conversion panel for accumulating radiation energy; a transport mechanism for transporting the radiographic image conversion panel; a detector for detecting a signal from the radiographic image conversion panel; or the like. Examples of the medical device in which the light source according to the invention can be provided include devices described in the publications of JP-A No. 2000-162726 and Japanese Patent No. 3360813, the disclosures of which are incorporated by reference herein.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

Hereinafter, the present invention will be described with reference to examples but is not limited thereto.

### EXAMPLES

### Example 1

A light source of Example 1 is manufactured as follows.

(Structure of Light Source)

Size of a linear pixel: 40 cm×50 μm (aspect ratio: 8,000), the number of pixel: 4,000, Pitch: 100 μm, Light emission area: 40 cm×40 cm, Structure of a linear pixel (an organic EL device): ITO/CuPc/NPD/mCP-Firpic (95:5, a mass ratio), a film thickness: 0.1 μm)/Balq/Alq/LiF/Al (a film thickness: 0.4 μm)

(Manufacturing Method)

On an ITO substrate(a soda glass) of 440×440×0.7 mm, 4001 pieces of dividing walls having a size of 40 cm×50 μm were formed at a pitch of 100 μm. In a pixel area between the diving walls on the substrate, CuPC (10 nm), NPD (30 nm), mCP (95 mass %), Firpic (5 mass %) (100 nm), Balq (10 nm), Alq (40 nm), LiF (0.5 nm), and Al (400 nm) were sequentially deposited according to a resistance heat deposition method. After connecting a lead to a negative electrode of each pixel, the pixel area was sealed by a sealing member having a drying agent.

Hereinafter, the structures of CuPc, NPD, mCP, Firpic, Balq, and Alq are illustrated.

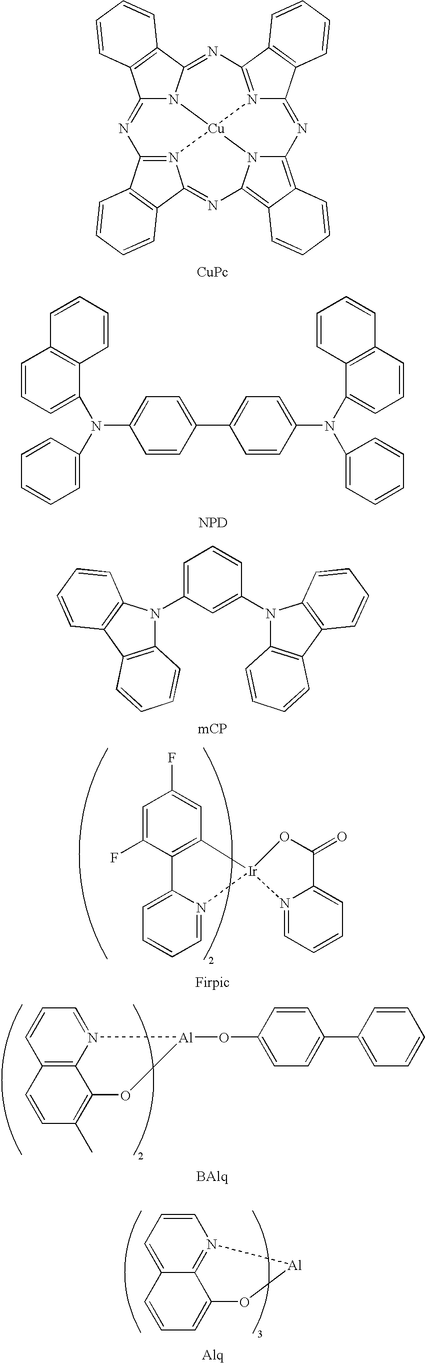

### Example 2

Except that the negative electrode of the organic EL device composing the linear pixel was changed into Al (film thickness: 1 μm) in Example 1, a light source of Example 2 was manufactured in the same manner as Example 1.

### Example 3

Except that the negative electrode of the organic EL device composing the linear pixel was changed into Al (film thickness: 2 μm) in Example 1, a light source of Example 3 was manufactured in the same manner as Example 1.

### Example 4

Except that the negative electrode of the organic EL device composing the linear pixel was changed into Al (film thickness: 0.01 μm)/Ag (film thickness: 0.4 μm) in Example 1, a light source of Example 4 was manufactured in the same manner as Example 1.

### Example 5

Except that the negative electrode of the organic EL device composing the linear pixel was changed into Al (film thickness: 0.05 μm)/Ag (film thickness: 0.4 μm) from the side of the organic compound layer in Example 1, a light source of Example 5 was manufactured in the same manner as Example 1.

### Example 6

Except that the negative electrode of the organic EL device composing the linear pixel was changed into Al (film thickness: 0.05 μm)/Ag (film thickness: 0.8 μm) from the side of the organic compound layer in Example 1, a light source of Example 6 was manufactured in the same manner as Example 1.

### Example 7

Except that the negative electrode of the organic EL device composing the linear pixel was changed into Al (film thickness: 0.05 μm)/Cu (film thickness: 0.8 μm) from the side of the organic compound layer in Example 1, a light source of Example 7 was manufactured in the same manner as Example 1.

### Example 8

Except that the negative electrode of the organic EL device composing the linear pixel was changed into Al (film thickness: 0.05 μm)/Cu (film thickness: 1.5 μm) from the side of the organic compound layer in Example 1, a light source of Example 8 was manufactured in the same manner as Example 1.

### Example 9

Except that the negative electrode of the organic EL device composing the linear pixel is changed into Al (film thickness: 0.2 μm) in Example 1, a light source of Example 9 is manufactured in the same manner as Example 1.

### Example 10

Except that the negative electrode of the organic EL device composing the linear pixel was changed into Ag (film thickness: 0.4 μm) in Example 1, a light source of Example 10 was manufactured in the same manner as Example 1.

### Example 11

Except that the negative electrode of the organic EL device composing the linear pixel was changed into Cu (film thickness: 0.4 μm) in Example 1, a light source of Example 11 was manufactured in the same manner as Example 1.

### Example 12

Except that the light emitting layer of the organic EL device composing the linear pixel was made into mCP—Firpic (95:5 (mass ratio), a film thickness: 30 nm) and the negative electrode was changed into Al (film thickness: 0.05 μm)/Ag (film thickness: 0.4 μm) from the side of the organic compound layer in Example 1, the light source of Example 12 was manufactured in the same manner as Example 1.

Each light source obtained in the above examples was evaluated as follows. Further, in the evaluations, the apparatuses used in measuring the light emission luminance and the external quantum efficiency were described above. The results are shown in a table 1.

1. The light emission luminance at 20V

2. The external quantum efficiency

3. A luminance ratio between an end and a center of the pixel (the end is away from the edge by 5 mm)

TABLE 1

| | Light emission | External | Luminance ratio |
|---|---|---|---|
| | luminance at 20 V | quantum | between end and |
| | (Cd/m²) | efficiency (%) | center of pixel (%) |
| Example 1 | 57,000 | 6.3 | 81 |
| Example 2 | 62,000 | 6.2 | 92 |
| Example 3 | 54,000 | 6.1 | 98 |
| Example 4 | 48,000 | 5.4 | 88 |
| Example 5 | 62,000 | 6.1 | 90 |
| Example 6 | 61,000 | 6.1 | 98 |
| Example 7 | 60,000 | 5.9 | 94 |
| Example 8 | 58,000 | 6.0 | 98 |
| Example 9 | 58,000 | 6.3 | 52 |
| Example 10 | 14,000 | 2.4 | 88 |
| Example 11 | 7,800 | 1.8 | 86 |
| Example 12 | 42,000 | 4.1 | 59 |

As shown in the table 1, in Examples 1 to 3 and 9 wherein the long- to short-side ratio (aspect ratio) of the linear pixel is 200 or more and only the film thickness of the negative electrode is different, the larger the film thickness of the negative electrode is, the more the luminance ratio of the end and the center of the pixel is improved. Therefore, it is found that the generation of the luminance unevenness can be prevented with keeping the high luminance and the high efficiency.

In Examples 4 to 8, the negative electrode is formed as a laminated structure in which a thin Al layer is combined with a thick Cu or Ag layer. Since the negative electrode has such a laminated structure, it is found that the generation of the luminance unevenness can be prevented while maintaining the same high luminance and high efficiency as in Examples 1 to 3, in which an Al layer thicker than those of Examples 4 to 8 is used as the negative electrode.

In addition, it is also found that the effect of preventing generation of the luminance unevenness becomes significant when the film thickness of the light emitting layer is 0.06 μm to 0.4 μm.

### Example 13

Except that the structure of the organic EL device in Example 1 was changed as follows, a light source of Example 13 was manufactured in the same manner as Example 1: ITO/CuPc (10 nm)/NPD (30 nm)/mCP (95 mass %): Firpic (5 mass %) (100 nm)/Balq2 (10 nm)/Alq3 (40 nm)/MgAg (10:1) (5 nm), Ag (5 nm)/ITO (20 nm)/CuPc (10 nm)/NPD (30 nm)/mCP (95 mass %): Firpic (5 mass %) (100 nm)/Balq2 (10 nm)/Alq3 (40 nm)/LiF (0.5 nm)/Al (400 nm).

The light source obtained in the above example 13 was evaluated according to the same evaluations as those in the above Examples, provided that since the organic EL device has the structure that there are two light emitting layers having the charge generating layer therebetween, the voltage to be applied to the organic EL device was 40V that corresponds to two times the voltage applied in the above examples. This result is shown in a table 2.

TABLE 2

| | Light emission | External | Luminance ratio |
|---|---|---|---|
| | luminance at 40 V | quantum | between end and |
| | (Cd/m2) | efficiency (%) | center of pixel (%) |
| Example 13 | 108,000 | 11.5 | 90 |

In the Example 13, the light source has the structure that there are two light emitting layers having the charge generating layer therebetween, and thus, the device resistance of the organic EL device becomes about twice as large as that of Example 1. Thereby, the influence due to the voltage drop at the electrode is decreased by about a half and it is found that the luminance unevenness is improved as compared to Example 1.

The present invention provides a light source comprising at least two linear pixels arranged in parallel, wherein the linear pixels comprise an organic electroluminescent device and an aspect ratio is large, and therefore, the light source is excellent in light emission luminance and light emission efficiency and can prevent generation of luminance unevenness.

Further, according to the present invention, since light emission is with a high accuracy and a high luminance, the gradation of the luminance can be controlled by a lighting line frequency and a power source circuit not needing current and voltage control becomes possible. Particularly, in an embodiment of the invention, by making the negative electrode into a low resistance using a metal (silver, copper or the like) with low resistance and into thick (0.4 μm to 2 μm), it is possible to prevent the luminance unevenness (at the thin film thickness, the resistance of the negative electrode becomes larger and the drop of voltage is generated, thereby the luminance unevenness is generated) generated at a normal thickness of the negative electrode (about 0.1 to 0.2 μm).

When the light source of the present invention is used for the reading light source or the like, it is possible to read an image (reflective original, transparent original, electronic latent image or the like) with a high degree of accuracy without needing a scanning machine mechanism. In addition, the visual effect can be improved by sequentially or randomly lighting the linear line pixels as a display sign light source. Further, according to the invention, since the light emission is with a high accuracy and a high luminance, the gradation of the luminance can be controlled by a lighting line frequency and a power source circuit not needing current and voltage control becomes possible.

In addition, as compared to a conventional light source such as a tube or a LED, the light source according to the invention has higher accuracy and higher evenness and is excellent in compactness of a device.

Further, as compared to the case of using an inorganic thin EL device, the light source according to the invention has higher luminance (particularly, in the blue to green regions) and a complicated operational circuit due to alternate current operation and noise suppression are not needed.

All publications, patent applications, and technical standards mentioned in this specification are herein incorporated by reference to the same extent as if each individual publication, patent application, or technical standard was specifically and individually indicated to be incorporated by reference.

What is claimed is:

1. A light source comprising at least two linear pixels arranged in parallel on a substrate, wherein the linear pixels comprise an organic electroluminescent device comprising a positive electrode, a negative electrode and at least one organic compound layer containing a light emitting layer between the positive electrode and the negative electrode, wherein an aspect ratio of the linear pixel is 200 or more, the positive electrode is shared by a plurality of linear pixels, and the negative electrode is patterned according to the linear pixels.

2. The light source of claim 1, wherein the film thickness of the negative electrode is 0.4 μm to 2 μm.

3. The light source of claim 1, wherein the negative electrode has a laminated structure, and the laminated structure comprises: a layer made of a material with a work function of 4 eV or less; and a layer made of a material with a volume resistivity lower than that of the layer with the work function of 4 eV or less, provided in the above order from the side of the organic compound layer.

4. The light source of claim 2, wherein the negative electrode has a laminated structure, and the laminated structure comprises: a layer made of a material with a work function of 4 eV or less; and a layer made of a material with a volume resistivity lower than that of the layer with the work function of 4 eV or less, provided in the above order from the side of the organic compound layer.

5. The light source of claim 1, wherein the negative electrode has a laminated structure, and the laminated structure comprises an aluminum layer and a silver layer, or an aluminum layer and a copper layer provided in the above order from the side of the organic compound layer.

6. The light source of claim 2, wherein the negative electrode has a laminated structure, and the laminated structure comprises an aluminum layer and a silver layer, or an aluminum layer and a copper layer provided in the above order from the side of the organic compound layer.

7. The light source of claim 5, wherein the film thickness of the aluminum layer is 0.01 μm to 0.05 μm, and the film thickness of the silver layer or the copper layer is 0.4 μm or more.

8. The light source of claim 6, wherein the film thickness of the aluminum layer is 0.01 μm to 0.05 μm, and the film thickness of the silver layer or the copper layer is 0.4 μm or more.

9. The light source of claim 1, wherein the film thickness of the light emitting layer is 0.06 μm to 0.4 μm.

10. The light source of claim 1, wherein the organic electroluminescent device comprises an organic compound layer, including two or more light emitting layers, between the positive electrode and the negative electrode, and a charge generating layer is formed between the two or more light emitting layers.

11. An exposure apparatus comprising the light source of claim 1.

12. An exposure apparatus comprising the light source of claim 10.

13. An image display unit comprising the light source of claim 1 as an image display part.

14. An image display unit comprising the light source of claim 10 as an image display part.

15. A medical device comprising the light source of claim 1.

16. A medical device comprising the light source of claim 10.
